(19) United States
(12) Patent Application Publication
(10) Pub. No.: US 2026/0284721 A1
(43) Pub. Date: Sep. 24, 2026

(54) Process for Chemically Cleaning Lithium Carbonate Scale from Surfaces of Equipment

(71) Applicant: Veolia Water Technologies, Inc., Cary, NC (US)

(72) Inventors: David E. Gamache, Oswego, IL (US); Jaclyn Kothanek, Chicago, IL (US)

(21) Appl. No.: 19/473,549

(22) PCT Filed: Apr. 9, 2024
(86) PCT No.: PCT/US2024/023662

§ 371 Date: Oct. 8, 2025

Related U.S. Application Data
(60) Provisional application No. 63/458,184, filed on Apr. 10, 2023.

(51) Int. Cl. B08B 9/08; B08B 3/08; B08B 3/10; C23G 1/14

(52) U.S. Cl. CPC B08B 9/083; B08B 3/08; B08B 3/102; C23G 1/14; B08B 2209/08

(57) ABSTRACT

The present invention relates to a process for removing lithium carbonate scale from the surfaces of equipment such as crystallizers and evaporators. A non-acid cleaning solution, such as water, is directed into the equipment. Once in the equipment, CO₂ is injected into the equipment and mixed with the cleaning solution. This causes the lithium carbonate scale to be converted to lithium bicarbonate which dissolves in the cleaning solution. Thereafter, the cleaning solution containing the dissolved lithium bicarbonate is discharged from the equipment.

### FIELD OF THE INVENTION

The present invention relates to processes for removing lithium carbonate scale from the surfaces of equipment used, for example, in the production of lithium hydroxide monohydrate.

### BACKGROUND OF THE INVENTION

Lithium hydroxide is an important component in rechargeable batteries and other devices. Systems and processes used in the production of lithium hydroxide utilize evaporation and crystallization systems to concentrate lithium hydroxide and ultimately crystallize lithium hydroxide monohydrate. In many cases, the lithium hydroxide is produced from brine that includes carbonate. Because the solubility of lithium carbonate decreases as temperature increases and/or due to water removal during the evaporation process, lithium carbonate often precipitates during evaporation of lithium hydroxide brine. As such, the evaporation system and other related equipment experience lithium carbonate scaling of equipment and heat transfer surfaces. This limits the operating times for the lithium hydroxide production equipment since the equipment must be cleaned so as to remove lithium carbonate scaling on a regular basis.

The low solubility of lithium carbonate makes lithium carbonate scale difficult to remove in a timely manner through simple water washing that can be effective for removal of other highly soluble scales. Therefore, typical methods for removal of lithium carbonate scale include either high pressure water washing (hydroblasting) or chemical cleaning using an acid solution to react with and dissolve the lithium carbonate scale. A wide variety of acids are effective but typical acids used for washing include nitric, hydrochloric, sulfuric, acetate or citric acid.

While hydroblasting can remove lithium carbonate scale, it is hard to remove scale completely as with chemical cleaning. This is especially true when the scale forms not just over heat transfer surfaces found in these systems, but is also found on vessel walls and in piping. In addition, hydroblasting is typically a contracted service and requires external resources subject to delays and availability. Finally, cleaning by a hydroblasting process is a lengthy process that can take days to complete.

Chemical cleaning can be a more expedient way of removing lithium carbonate scale. However, the use of acid solutions raises concerns about increased corrosion potential in the equipment, as well as safety concerns about handling the typically hot acid solutions. Disposal of spent acid solutions can also be difficult and expensive. Further, a residual acid solution that is not fully evacuated after cleaning can lead to product contamination upon restart.

Therefore, there is a real need for an effective way of removing lithium carbonate scale from equipment surfaces that overcomes the disadvantages and drawbacks of hydroblasting and chemical cleaning with acids.

### SUMMARY OF THE INVENTION

The present invention relates to a process of removing lithium carbonate scale from surfaces of equipment. A cleaning solution in the form of water or an aqueous solution is directed into the equipment and contacts the lithium carbonate scale. With the presence of lithium carbonate in the equipment, the cleaning solution assumes a pH greater than 9, and typically as high as 12 or above. CO₂ is mixed with the cleaning solution in the equipment which causes the lithium carbonate scale to be converted to lithium bicarbonate. Lithium bicarbonate is more soluble than lithium carbonate, and subsequently dissolves in the cleaning solution. As the conversion continues and the scale becomes dissolved, there will be a reduction in the pH of the cleaning solution to approximately 7-9 near the end of the cleaning process. The cleaning solution containing the lithium bicarbonate is then discharged from the equipment. This cleaning process is typically carried out in the range of 10-50° C.

The process for removing lithium carbonate scale from equipment services can be implemented as a batch process or a continuous process. When implemented as a continuous process, the cleaning solution can be continuously circulated through the equipment. After a period of circulation in the equipment, spent cleaning solution can be purged from the equipment. If required, the process can continue with periods of feeding cleaning solution into the equipment along with continued CO2 addition followed by periods of purging spent cleaning solution.

In one embodiment the present invention entails:
A process for removing lithium carbonate scale from surfaces of equipment, comprising:
   a. directing a cleaning solution in the form of water or an aqueous solution into the equipment and into contact with the lithium carbonate scale formed on the surfaces of the equipment which results in the pH of the cleaning solution being greater than 9;
   b. converting the lithium carbonate scale to lithium bicarbonate by mixing CO₂ with the cleaning solution and reducing the pH of the cleaning solution to approximately 7-9; wherein converting the lithium carbonate scale to lithium bicarbonate results in the lithium bicarbonate becoming dissolved in the cleaning solution; and
   c. discharging the cleaning solution containing the dissolved lithium bicarbonate from the equipment.

In another embodiment, the present invention entails:
A process for removing lithium carbonate scale from surfaces of equipment, comprising:
   a. directing a non-acid cleaning solution having a temperature less than 50° C. into the equipment and into contact with the lithium carbonate scale formed on the surfaces of the equipment;
   b. wherein the cleaning solution is water or an aqueous solution;
   c. circulating the cleaning solution through the equipment;
   d. converting the lithium carbonate scale to lithium bicarbonate by mixing CO₂ with the cleaning solution;
   e. wherein converting the lithium carbonate scale to lithium bicarbonate results in the lithium carbonate dissolving in the cleaning solution; and
   f. discharging the cleaning solution containing the dissolved lithium carbonate from the equipment.

In yet another embodiment, the present invention entails:
A process for removing lithium carbonate scale from the interior surfaces of a crystallizer or evaporator, wherein the crystallizer or evaporator includes a vapor body, heat exchanger and associated piping, the process comprising:
   a. directing a cleaning solution in the form of water or an aqueous solution into the crystallizer or evaporator and flooding the vapor body, heat exchanger and associated piping of the crystallizer or evaporator with the cleaning solution;
   b. after the cleaning solution has been directed into the crystallizer or evaporator, directing CO₂ from a CO₂ source into the crystallizer or evaporator and mixing the CO₂ with the cleaning solution in the crystallizer or evaporator;
   c. after the CO2 has been mixed with the cleaning solution, circulating the cleaning solution over the surfaces of the vapor body, heat exchanger and associated piping, and in the process converting the lithium carbonate scale on the surfaces of the vapor body heat exchanger and the associated piping to lithium bicarbonate;
   d. dissolving the lithium bicarbonate into the cleaning solution; and
   e. discharging the cleaning solution containing the dissolved lithium carbonate from the crystallizer or evaporator.

Other objects and advantages of the present invention will become apparent and obvious from a study of the following description and the accompanying drawings which are merely illustrative of the invention.

### DESCRIPTION OF THE DRAWING

FIG. 1 is a schematic illustration of a forced circulation crystallizer and illustrates one example of a process for removing lithium carbonate scale from interior surfaces of the crystallizer.

### DESCRIPTION OF EXEMPLARY EMBODIMENTS

As discussed above, equipment used in the production of lithium tends to experience lithium carbonate scaling of equipment surfaces. The present invention entails a cleaning process for removing lithium carbonate scale from equipment surfaces without using acids. Instead, as explained below, the pH of a cleaning solution in the equipment is adjusted to a generally neutral range of approximately 7-9 which results in the lithium carbonate scale being converted to lithium bicarbonate which is more soluble than lithium carbonate. The converted lithium bicarbonate dissolves in the cleaning solution and the cleaning solution can be discharged or purged from the equipment.

The chemical cleaning process can be used to remove lithium carbonate scale from evaporators, crystallizers, tanks or vessels, piping and any other equipment which includes liquid carbonate scaling. Further, the chemical cleaning process described can be implemented as a batch process or as a continuous cleaning process. In a batch process, the cleaning solution will remain in the equipment for a selected period of time while being circulated. After the cleaning solution enters the equipment, it will have an initially high pH around 12 due to dissolution of some lithium carbonate. During the batch process, the CO2 is added continuously until the lithium carbonate is converted to lithium bicarbonate sufficiently to remove the scale at which point the cleaning solution is having a pH of approximately 7-9 Once it is determined that the process has successfully cleaned the lithium carbonate scale from the equipment surfaces, the cleaning solution containing dissolved lithium bicarbonate is discharged or purged from the equipment. In many cases, a single batch process will perform a successful cleaning operation, especially if initiated in a timely fashion. In some cases, it may be necessary to perform multiple batch cleaning processes due to a high degree of lithium carbonate scaling on the surfaces of the equipment.

In a continuous process, the cleaning solution is directed into the equipment and continuously circulated through the equipment. In one example, the cleaning solution is continuously circulated for a selected time period. During this period, additional cleaning solution could be added continuously and spent cleaning solution could be removed continuously all the while continuing to add CO2. Thereafter, the circulation is stopped and the spent cleaning solution containing the dissolved lithium bicarbonate is purged from the equipment.

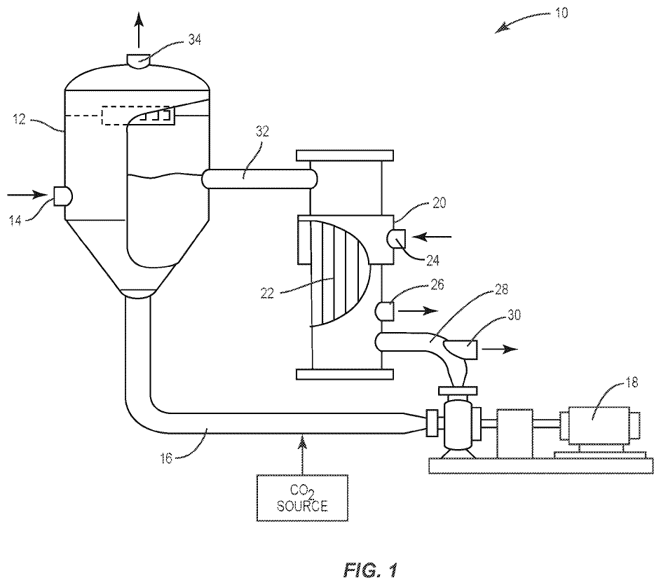

FIG. 1 is a schematic illustration of a forced circulation crystallizer, indicated generally by the numeral 10, and which is an example of a crystallization system that might be used in a lithium production process. The design and operation of the forced circulation crystallizer 10 is well known and appreciated by those skilled in the art. However, a brief review of the major components of the crystallizer 10 may be helpful. It includes a vapor body 12 that includes a feed inlet 14. During the course of the crystallization process, concentrate or liquor is held in a bottom portion of the vapor body. A concentrate line 16 extends from the bottom portion of the vapor body 12 to a recirculation pump 18. Recirculation pump 18 pumps the liquor or concentrate through line 28 into a heat exchanger indicated generally by the numeral 20. Heat exchanger 20 includes a plurality of tubes disposed within a housing. The housing of the heat exchanger includes a steam inlet 24 and a condensate outlet 26. During a crystallization process, the recirculation pump 18 pumps liquor or concentrate from the vapor body 12 into and through heat transfer tubes 22 and out the heat transfer tubes into line 32 which leads back to the vapor body 12. During the crystallization process, the concentrate passing through the heat exchanger 20 is heated by injecting steam into the steam inlet 24 which in turn heats the concentrate or liquor passing through the heat transfer tubes 22. Resulting condensate is discharged through the condensate outlet 26. During the crystallization process, a portion of the concentrate, sometimes referred to as the product, is discharged from the outlet 30 formed in line 28. Steam generated in the crystallizer 10 is exhausted from a vapor outlet 34 formed in the upper portion of the vapor body 12.

The forced circulation crystallizer 10 and similar evaporators and crystallizers may be employed in various ways in a lithium production process. For the sake of presenting an example, assume that the forced circulation crystallizer 10 is used to concentrate and crystallize a lithium hydroxide brine that contains carbonate. In the process, lithium carbonate will form scale on the interior surfaces of the crystallizer due, in part at least, to having an inverse solubility with respect to temperature. So during the course of concentrating and crystallizing the lithium hydroxide brine, interior surfaces of the crystallizer 10 will experience lithium carbonate scaling.

As discussed above, the cleaning process can be implemented as either a batch process or a continuous process. For purposes of explanation, the continuous implementation will be discussed. A cleaning solution, such as water or an aqueous solution, is fed into the crystallizer 10 via the feed inlet 14. The entire crystallizer 10, including the vapor body 12, heat exchanger 20, and associated piping is flooded with the cleaning solution. Various outlets are closed in order to maintain the cleaning solution in the crystallizer 10. Because of the presence of carbonate already in the crystallizer, it follows that the pH of the cleaning solution, once in the crystallizer, will typically increase above 9 and in some cases will increase to 12 or above. As seen in FIG. 1, there is a CO₂ source operatively connected to the crystallizer 10. In this example, the CO₂ source is designed to inject CO₂ into the cleaning solution at a point just upstream of the recirculation pump 18. Once cleaning solution is contained throughout the crystallizer 10, the recirculation pump 18 circulates the cleaning solution through the heat exchanger 20 and through the vapor body 12 and back to the recirculation pump. This is continued and while the cleaning solution is being circulated, CO₂ is injected into the cleaning solution and mixed therewith. Sufficient CO₂ is injected into the cleaning solution in order to reduce the pH of the cleaning solution to generally neutral pH, on the order of approximately 7-9. The pH of the cleaning solution can be monitored and the quantity of CO₂ injected into the cleaning solution can be controlled so as to maintain the pH of the cleaning solution in the range of 7-9. This pH range will effectively convert all or at least a substantial portion of the lithium carbonate scale to lithium bicarbonate which is more soluble than lithium carbonate. The converted lithium bicarbonate dissolves in the cleaning solution as it is circulated through the crystallizer 10. Once it is determined that the lithium carbonate scale has been successfully removed from the interior surface of the crystallizer, the cleaning solution is discharged or purged through one of the outlets in the crystallizer 10. In some cases, that will be sufficient to remove a targeted amount of the lithium carbonate scale. In other cases, it may be necessary to again fill the crystallizer 10 with the cleaning solution and circulate the solution through the crystallizer as described above. In fact, in some cases, the process can include repeated cycles of feed and purge. In some cases, it may be desirable to pressurize the cleaning solution in the crystallizer or other equipment. By pressurizing the system containing the cleaning solution, the solubility of CO₂ in the water or aqueous solution is increased and that, in turn, is helpful in reducing the pH of the cleaning solution to a near neutral pH.

There are many advantages to the present invention. One advantage is that the invention allows for chemical cleaning at near neutral pH (in the range of 7-9). This results in the spent cleaning solution being safer to handle and at the same time, this minimizes corrosion risk. Unlike other conventional chemical washing techniques, this method allows for the more likely potential for lithium recovery from the spent cleaning solution through either thermal treatment or by raising the pH. While recovery of lithium in conventional chemical cleaning is conceivable, the acids used typically require additional chemicals for increasing the pH due to the low pH of the wash solution. In addition, the acid used will tend to contaminate the recovered lithium with nitrate, chloride, sulfate, acetate or citrate, depending on the acid used. With carbon dioxide, no additional contaminants to the process would be added and recovery of the lithium faces no risk of contamination from cleaning chemicals.

Also, it should be noted that the spent cleaning solutions from conventional chemical cleaning may be done only after neutralization and could potentially involve the requirement that the disposal be through a licensed waste disposal entity-resulting in a loss of the lithium content that might otherwise be recovered as product. Finally, the carbon dioxide used in the process is typically available at the plants involved and does not require procurement of external expertise or chemicals that would not normally be available on site. Indeed, the use of carbon dioxide represents a lower cost chemical and does not require other additional chemicals, such as corrosion inhibitors.

The above discussion has mentioned lithium carbonate scaling in the context of a crystallizer and the production of lithium hydroxide monohydrate. Lithium carbonate scaling, however, may occur in various equipment and systems employed in the course of various other lithium production processes. The process of removing lithium carbonate scale discussed here applies to all lithium production processes and the equipment used. The term “equipment” as used herein is broadly defined to include crystallizers, evaporators, pipes, vessels, tanks, systems, and other structures and surfaces found in lithium production processes that might experience lithium carbonate scaling.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

1-12. (canceled)

13. A process for removing lithium carbonate scale from the interior surfaces of a crystallizer or evaporator, wherein the crystallizer or evaporator includes a vapor body, heat exchanger and associated piping, the process comprising:
directing a non-acid cleaning solution in the form of water or an aqueous solution into the crystallizer or evaporator and flooding the vapor body, heat exchanger and associated piping of the crystallizer or evaporator with the non-acid cleaning solution;
after the non-acid cleaning solution has been directed into the crystallizer or evaporator, directing CO₂ from a CO₂ source into the crystallizer or evaporator and mixing the CO₂ with the non-acid cleaning solution in the crystallizer or evaporator;
after the CO₂ has been mixed with the non-acid cleaning solution, circulating the non-acid cleaning solution over the surfaces of the vapor body, heat exchanger and associated piping, and in the process converting the lithium carbonate scale on the surfaces of the vapor body heat exchanger and the associated piping to lithium bicarbonate;
dissolving the lithium bicarbonate into the non-acid cleaning solution; and
discharging the non-acid cleaning solution containing the dissolved lithium bicarbonate from the crystallizer or evaporator.

14. The process of claim 13 wherein, prior to mixing the CO₂ with the non-acid cleaning solution, the pH of the non-acid cleaning solution in the crystallizer or evaporator is greater than 7 and wherein after mixing the CO₂ with the non-acid cleaning solution and converting the lithium carbonate scale to lithium bicarbonate, the pH of the non-acid cleaning solution is reduced to approximately 7-9.

15. The process of claim 13 implemented as a batch process wherein the non-acid cleaning solution remains in the crystallizer or evaporator for a selected period of time, and during the selected period of time, the non-acid cleaning solution is circulated through the evaporator or the crystallizer; and during the batch process, the CO₂ is added continuously until the lithium carbonate scale is converted to lithium bicarbonate.

16. The process of claim 15 wherein the non-acid cleaning solution initially assumes a pH of approximately 12 in the evaporator or crystallizer.

17. The process of claim 16 including reducing the pH of the non-acid cleaning solution from approximately 12 to approximately 7-9 such that over a period of time, the pH of the non-acid cleaning solution in the evaporator or crystallizer varies between approximately 12 and approximately 7-9.

18. The method of claim 13 including maintaining the temperature of the non-acid cleaning solution below 50° C.

19. The method of claim 13 including pressurizing the non-acid cleaning solution in the crystallizer or evaporator.

20. A process for removing lithium carbonate scale from surfaces of equipment, comprising:
directing a non-acid cleaning solution having a temperature less than 50° C. into the equipment and into contact with the lithium carbonate scale formed on the surfaces of the equipment;
wherein the non-acid cleaning solution is water or an aqueous solution;
circulating the non-acid cleaning solution through the equipment;
converting the lithium carbonate scale to lithium bicarbonate by mixing CO₂ with the non-acid cleaning solution;
wherein converting the lithium carbonate scale to lithium bicarbonate results in the lithium bicarbonate dissolving in the non-acid cleaning solution; and
discharging the non-acid cleaning solution containing the dissolved lithium bicarbonate from the equipment.

21. The process of claim 20 wherein initially the non-acid cleaning solution after contacting the lithium carbonate scale has a pH greater than 9; and wherein converting the lithium carbonate scale to lithium bicarbonate by mixing CO₂ with the non-acid cleaning solution reduces the pH of the non-acid cleaning solution to approximately 7-9.

22. The process of claim 20 including mixing sufficient CO₂ with the non-acid cleaning solution to reduce the pH of the non-acid cleaning solution to approximately 7-9.

23. The process of claim 20 including mixing sufficient CO₂ with the non-acid cleaning solution to convert all or at least a substantial portion of the lithium carbonate scale to lithium bicarbonate.

24. The process of claim 20 implemented as a batch process wherein the non-acid cleaning solution remains in the equipment for a selected period of time and during the selected period of time, the non-acid cleaning solution is circulated through the equipment and during the batch process, the CO₂ is continuously added to the non-acid cleaning solution in the equipment until the lithium carbonate scale is converted to lithium bicarbonate.

25. The process of claim 21 wherein the non-acid cleaning solution initially assumes a pH of approximately 12 in the equipment.

26. The process of claim 25 further including reducing the pH of the non-acid cleaning solution from approximately 12 to approximately 7-9.

27. The process of claim 20 including maintaining the temperature of the non-acid cleaning solution below 50° C. in the equipment.

28. The process of claim 20 including pressurizing the non-acid cleaning solution in the equipment.

29. A process for removing lithium carbonate scale from surfaces of equipment, comprising:
directing a non-acid cleaning solution in the form of water or an aqueous solution into the equipment and into contact with the lithium carbonate scale formed on the surfaces of the equipment which results in the pH of the non-acid cleaning solution being greater than 9;
converting the lithium carbonate scale to lithium bicarbonate by mixing CO₂ with the non-acid cleaning solution and reducing the pH of the non-acid cleaning solution to approximately 7-9;
wherein converting the lithium carbonate scale to lithium bicarbonate results in the lithium bicarbonate becoming dissolved in the non-acid cleaning solution; and
discharging the non-acid cleaning solution containing the dissolved lithium bicarbonate from the equipment.

30. The process of claim 29 wherein the removal of lithium carbonate scale from the surfaces of the equipment is implemented without the use of acid.

31. The process of claim 29 wherein, during the process of removing lithium carbonate scale from the surfaces of the equipment, the temperature of the cleaning solution is maintained below 50° C.

32. The process of claim 29 further including enhancing the removal of lithium carbonate scale by pressurizing the non-acid cleaning solution in the equipment during the removal of lithium carbonate scale.
